(19) United States
(12) Patent Application Publication
(10) Pub. No.: US 2019/0019249 A1
(43) Pub. Date: Jan. 17, 2019

(54) Methods, Systems, Networks, And Media For Generating Personal Profile Scores Using A Geo-Location Based Model

(71) Applicant: Mastercard International Incorporated, Purchase, NY (US)

(72) Inventors: Manash Bhattacharjee, Jersey City, NJ (US); Stephane Wyper, Weehawken, NJ (US)

(73) Assignee: Mastercard International Incorporated, Purchase, NY (US)

(21) Appl. No.: 15/648,023

(22) Filed: Jul. 12, 2017

(51) Int. Cl. G06Q 40/02

(52) U.S. Cl. CPC G06Q 40/025; G06F 17/30241

(57) ABSTRACT

An apparatus for generating personal profile scores can include a processor that can receive, from different sensors, different types of sensor measurements for different individuals. The processor can calculate individual sensor scores corresponding to different types of sensor measurements. The processor can calculate a regional average score for different types of sensor measurements based on the sensor measurements from a subset of sensors associated with individuals located in a particular geographic region. The processor can determine an adjusted sensor score for each of different types of sensor measurements, wherein the adjusted sensor score for each type of sensor measurement comprises an individual sensor score normalized by a corresponding regional average score for that corresponding type of sensor measurement. The processor can determine an adjusted personal profile score by compositing the adjusted sensor scores for each of the different types of sensor measurements.

### BACKGROUND

The disclosed subject matter relates to methods, systems, networks, and media for generating personal profile scores using a geo-location based model of sensor data.

The various sensors contained in phones, computers, fitness trackers, and other IOT (Internet of Things) devices allow a large amount of data to be obtained about an individual's behavior. This data can then be used as input for various decision-making processes related to the individual. However, in order for the data to be correctly used for this purpose, the individual's behavior, as measured by the various sensors, must be understood in a larger context.

Accordingly, there exists a need for improved systems and processes to generate personal profiles of individuals that accurately reflect their behavior.

### SUMMARY

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

To achieve these and other advantages and in accordance with the purpose of the disclosed subject matter, as embodied and broadly described, a computer-implemented method for generating personal profile scores is disclosed. The computer-implemented method can include receiving, at a processor and from a plurality of sensors, a plurality of different types of sensor measurements for each of a plurality of individuals. The method can include calculating, by the processor and for each of the plurality of individuals, individual sensor scores corresponding to each of the plurality of different types of sensor measurements. The method can include calculating, by the processor, a regional average score for each of the plurality of different types of sensor measurements based on the sensor measurements from a subset of the plurality of sensors associated with individuals located in a particular geographic region. The method can include determining, by the processor and for each of the plurality of individuals, an adjusted sensor score for each of the plurality of different types of sensor measurements. The adjusted sensor score for each type of sensor measurement can include an individual sensor score normalized by a corresponding regional average score for that corresponding type of sensor measurement. The method can include determining, by the processor and for each of the plurality of individuals, an adjusted personal profile score by compositing the adjusted sensor scores for each of the plurality of different types of sensor measurements.

For purpose of illustration and not limitation, the method can include determining, by the processor and for each of the plurality of different types of sensor measurements, a weighting value corresponding to that type of sensor measurement. In some embodiments, the adjusted profile score can be calculated by compositing weighted adjusted sensor scores for each of the plurality of different types of sensor measurements. A weighted adjusted score can include an adjusted score for a particular type of sensor measurement weighted by the weighting value corresponding to that type of sensor measurement.

For purpose of illustration and not limitation, each of the plurality of sensors can be a networked device that communicates, to the processor, a particular type of sensor measurement comprising measurement data collected for an individual.

For purpose of illustration and not limitation, calculating the individual sensor scores can include determining, by the processor, the type of sensor measurement of each sensor measurement received from a sensor and calculating, by the processor, an individual sensor score based on one or more sensor measurements received from one or more of the plurality of sensors corresponding to a particular type of sensor measurement. The individual sensor score can be calculated by comparing the one or more sensor measurements against a range of expected values for the determined type of sensor measurement.

For purpose of illustration and not limitation, calculating a regional average score can further include determining, by the processor, a geographic region associated with each of the received sensor measurements and calculating, by the processor and for each of the plurality of different types of sensor measurements, an average of all received sensor measurements for a given type of sensor measurement that is associated with the geographic region. In some embodiments, the geographic region associated with each of the received sensor measurements can be determined by either determining, by the processor, the geographic region at which a sensor producing the sensor measurements is located or determining, by the processor, the geographic region at which the individual corresponding to the received sensor measurements is located.

For purpose of illustration and not limitation, the method can include determining, by the processor, whether an individual has a preexisting credit score based on their financial history. Upon determining that individual has a preexisting credit score, the method can include generating, by the processor, a composite personal profile score based on the preexisting credit score and the adjusted personal profile score. Upon determining that individual does not have a preexisting credit score, the method can include providing, by the processor, the adjusted personal profile score as a measure of creditworthiness of the individual in lieu of a credit score to entities that require a credit score.

In accordance with another aspect of the disclosed subject matter, an apparatus for generating personal profile scores is disclosed. The apparatus can include a processor configured to communicate with a plurality of sensors. The processor can be configured to receive, from the plurality of sensors, a plurality of different types of sensor measurements for each of a plurality of individuals. The processor can be configured to calculate, for each of the plurality of individuals, individual sensor scores corresponding to each of the plurality of different types of sensor measurements. The processor can be configured to calculate a regional average score for each of the plurality of different types of sensor measurements based on the sensor measurements from a subset of the plurality of sensors associated with individuals located in a particular geographic region. The processor can be configured to determine, for each of the plurality of individuals, an adjusted sensor score for each of the plurality of different types of sensor measurements, wherein the adjusted sensor score for each type of sensor measurement comprises an individual sensor score normalized by a corresponding regional average score for that corresponding type of sensor measurement. The processor can be configured to determine, for each of the plurality of individuals, an adjusted personal profile score by compositing the adjusted sensor scores for each of the plurality of different types of sensor measurements.

It is to be understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the disclosed subject matter. Together with the description, the drawings serve to explain the principles of the disclosed subject matter.

### BRIEF DESCRIPTION OF THE DRAWINGS

FIG. 1 is a diagram illustrating a system for generating personal profile scores using a geo-location based model of sensor data according to an illustrative embodiment of the disclosed subject matter.

FIG. 2 is a diagram illustrating a representative method in which various components of the disclosed IOT-based score module can generate personal profile scores using a geo-location based model of sensor data according to an illustrative embodiment of the disclosed subject matter.

FIG. 3 is a diagram illustrating a representative database generated by the disclosed IOT-based score module to generate personal profile scores using a geo-location based model of sensor data according to an illustrative embodiment of the disclosed subject matter.

FIG. 4 is a flow chart illustrating a representative method, for generating personal profile scores using a geo-location based model of sensor data, implemented according to an illustrative embodiment of the disclosed subject matter.

FIG. 5 is a block diagram illustrating further details of a representative computer system according to an illustrative embodiment of the disclosed subject matter.

Throughout the drawings, the same reference numerals and characters, unless otherwise stated, are used to denote like features, elements, components or portions of the illustrated embodiments. Moreover, while the present disclosed subject matter will now be described in detail with reference to the figures, it is done so in connection with the illustrative embodiments.

### DETAILED DESCRIPTION

Reference will now be made in detail to the various exemplary embodiments of the disclosed subject matter, exemplary embodiments of which are illustrated in the accompanying drawings. The structure and corresponding method of operation of the disclosed subject matter will be described in conjunction with the detailed description of the system.

The methods, systems, networks, and media presented herein can be used for generating personal profile scores using a geo-location based model of sensor data. With the proliferation of Internet-connected devices and items with embedded with electronics, software, sensors, actuators, and having network connectivity capability, a vast amount of data can be collected about several aspects of individuals' day to day lives and their activities. Such unprecedented amount of data provided by these inter-networked sensory devices, hereinafter also referred to as Internet of Things (IOT) devices can collect data for several different aspects of individuals' daily activities, providing insight into their behaviors and activities. The data collected by these various IOT devices can be analyzed using a geo-location model to generate personal profile scores of individuals that correspond to the users of the monitored IOT devices. In some embodiments, the disclosed subject matter can use these IOT device-based personal profile scores to provide a creditworthiness for individuals that lack a credit score and/or credit history. In some other embodiments, the disclosed subject matter can use these IOT device-based personal profile scores to supplement preexisting credit scores and/or the credit history of an individual to provide a more holistic measure of the individuals' creditworthiness that cannot be obtained through analysis of their financial activity and/or financial history. In some embodiments, the disclosed subject matter can use these IOT device-based personal profile scores for applications beyond credit lending purposes in which different institutions require an individual's credit history and/or credit score to determine whether to approve the individual for credit lending. For example, the IOT device-based personal profile scores can be generated to provide to other institutions such as insurance companies, retail banks, wealth management firms, credit and/or debit card companies, and several other institutions with data to determine the behavior, attentiveness, diligence, carefulness, creditworthiness, and/or other valuations of an individual's characteristics. Since the IOT device-based personal profile score can be constantly updated and/or can cover several different aspects of an individual's activities in addition to their financial behavior, the IOT device-based personal profile score can be provided to these other institutions that require a quantifiable measure of the user's monitored behaviors that cannot be obtained by examining an individual's credit score alone.

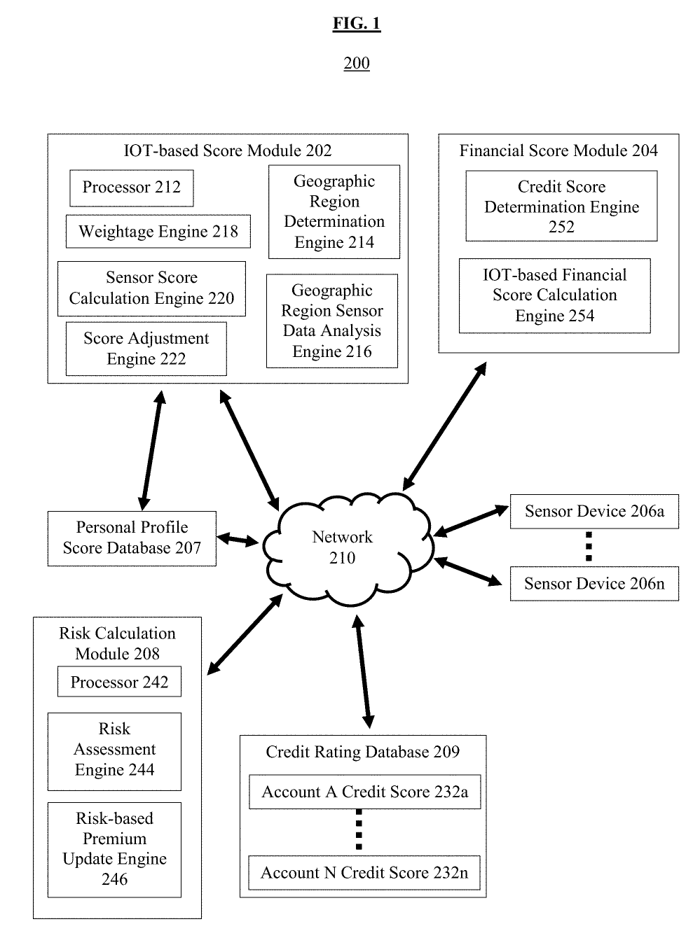

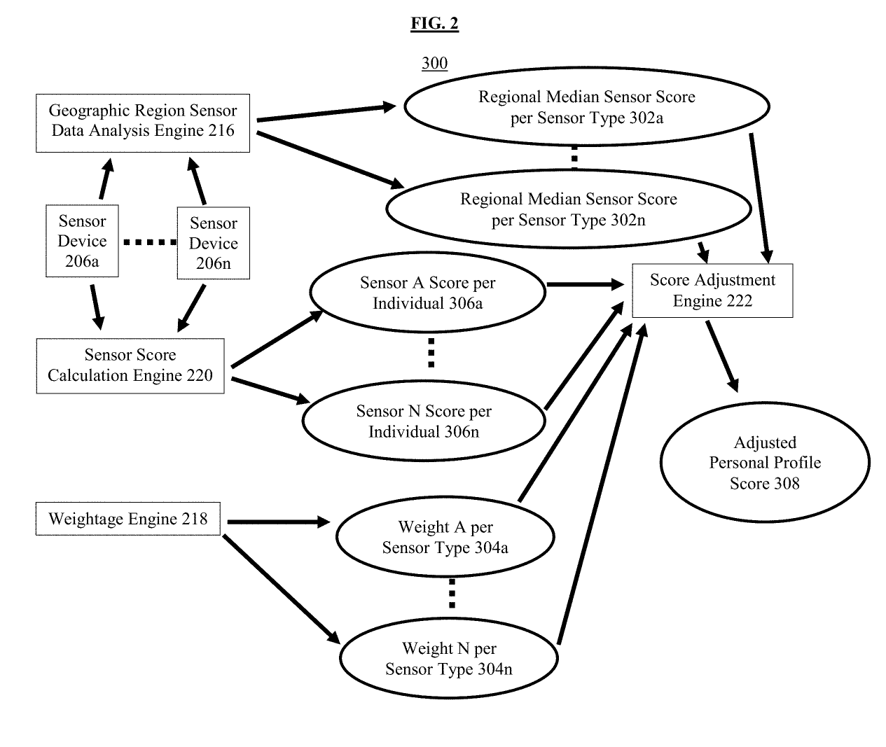

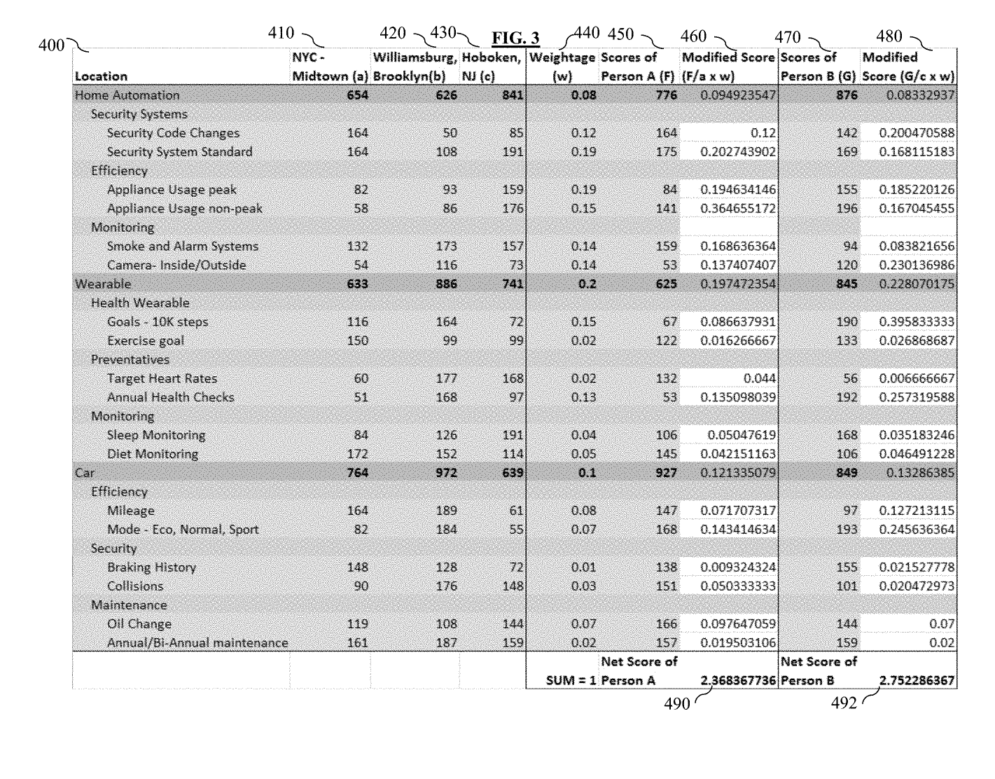

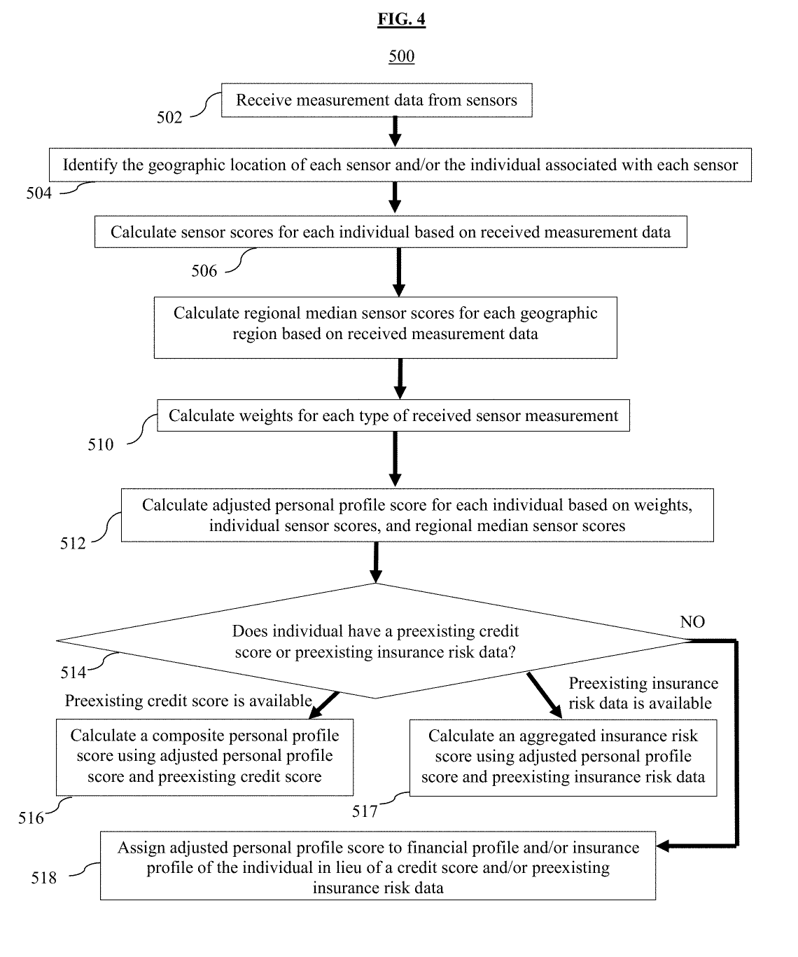

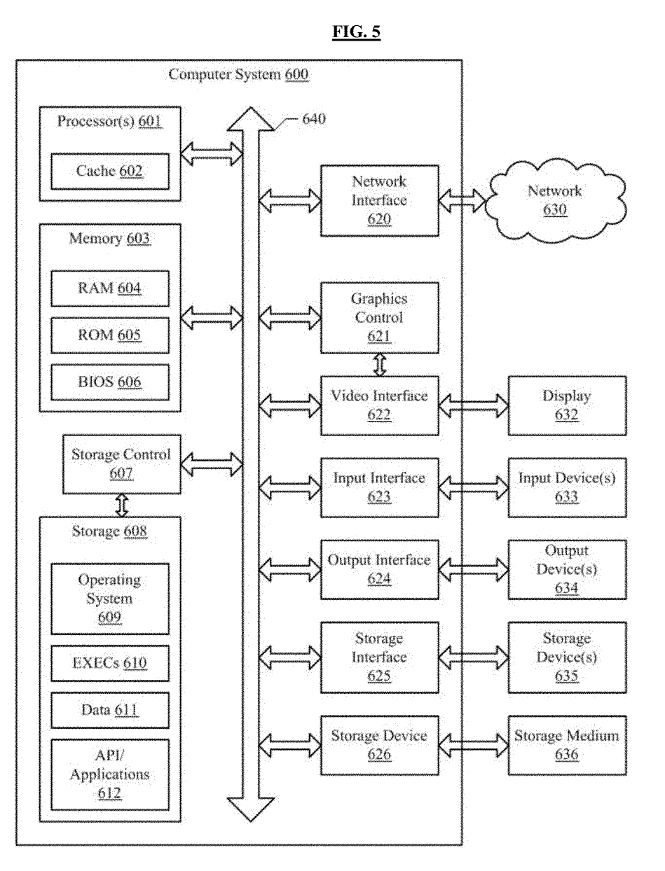

The accompanying figures, where like reference numerals refer to identical or functionally similar elements throughout the separate views, further illustrate various embodiments and explain various principles and advantages all in accordance with the disclosed subject matter. For purpose of explanation and illustration, and not limitation, FIG. 1 shows an exemplary block diagram of a system for generating personal profile scores using a geo-location based model of sensor data in accordance with the disclosed subject matter. FIG. 2 shows an exemplary embodiment of a method for generating personal profile scores using a geo-location based model of sensor data in accordance with the disclosed subject matter. FIG. 3 shows an example of a database of personal profile scores generated by the disclosed system in accordance with the disclosed subject matter. FIG. 4 shows an exemplary embodiment of a method for generating personal profile scores using a geo-location based model of sensor data in accordance with the disclosed subject matter. An exemplary embodiment of a computer system for use with the disclosed subject matter is shown in FIG. 5. While the present disclosed subject matter is described with respect to using methods, systems, networks, and media for generating personal profile scores using a geo-location based model of sensor data, one skilled in the art will recognize that the disclosed subject matter is not limited to the illustrative embodiments. For example, the disclosed methods, systems, networks, and media for generating personal profile scores using a geo-location based model of sensor data can be used with a wide variety of non-e-commerce transaction settings, such as to calculate other types of scores, such as determining individuals' behavior, athletic and/or fitness data of the individual, shopping preferences, and a variety of other user preferences, in addition to creditworthiness scores from the collected IOT device data and normalized using the geo-location model. In some embodiments, the personal profile scores can be used for retail banking, card payment, insurance, wealth management, and savings purposes as a quantifiable measure of the user's monitored behaviors. For example, these institutions can use generated personal profile scores for individuals to determine whether to provide them with specific discounts, privileges, rewards, penalties, and/or to determine pricing based on the individuals' monitored behaviors as quantified by the personal profile scores.

FIG. 1 depicts a block diagram illustrating a representative system 200 generating personal profile scores using a geo-location based model of sensor data. The exemplary system 200 can include at least an IOT-based score module 202, a financial score module 204, multiple different sensor devices 206a-206n, a personal profile score database 207, and a credit rating database 209, which can all communicate with each other over network 210. Network 210 may be a wireless network, local area network, the world wide web, or any other suitable network.

In some embodiments, the IOT-based score module 202 and financial score module 204 can be both a part of the same entity and can share computing resources. For example, the IOT-based score module 202 and financial score module 204 can share the same processor 212 and/or can share processing circuitry and/or processing software. In some other embodiments, the IOT-based score module 202 and financial score module 204 can be independent entities that do not share the same resources and can be located in different locations.

As embodied herein, the IOT-based score module 202 can include a processor 212, a geographic region determination engine 214, a geographic region sensor analysis engine 216, a sensor score calculation engine 220, and a score adjustment engine 222. In some embodiments, the IOT-based score module 202 can communicate with and receive sensor data from multiple different networked sensors devices 206a-206n via network 210.

In some embodiments, sensor devices 206a-206n can be various different types of IOT devices that collect data about an individual's various activities. Such data would be collected only in accordance with all applicable data privacy laws and/or regulations and after obtaining the consent of the individual. For example, sensor devices 206a-206n can include home automation devices such as home security systems that monitor security code changes and the security system standard used by the individual to protect and secure his/her home and collect data on the amount of breaches to the individual's home, if any, to determine how secure the individual is. As another example, sensor devices 206a-206n can include appliance efficiency monitors (e.g., smart AC systems, home energy monitors, etc.) that monitor appliance usage during peak power consumption times and during non-peak power consumption times. As another example, sensor devices 206a-206n can include home monitoring devices such as smoke monitors, carbon monoxide monitors, security camera, and other types of alarm systems to trigger alarms when any unusual and/or alarm conditions are triggered in the individuals' home is detected. As another example, sensor devices 206a-206n can include wearable devices such as fitness trackers, smartwatches, heart rate monitors, and smart clothes, to monitor the individuals' health and fitness levels (e.g., Fitbit, Jawbone, Garmin Vivosmart, Garmin Vivoactive, Garmin Vivomove, Garmin Forerunner, Withings Steel HR, Apple Watch, Huawei Watch, Xiaomi Mi Band, Moov Now, Tomtom Touch, Samsung Gear Fit, JBL UA Sport Wireless Heart Rate Headphones, Myontec Mbody connected shorts), track how much of their preset fitness goals an individual accomplishes on a daily basis, and monitors sleep activity, diet, heart rates, and performs other health checks on the individuals wearing such wearable IOT devices. As another example, sensor devices 206a-206n can include automobile sensors that monitor driving information such as mileage efficiency, the type of vehicle operation (e.g., eco-friendly mode, normal, sport mode), route efficiency information from GPS sensors and/or whether GPS mode is enabled. Such automobile sensor devices can also monitor the driving performance (e.g., number of collisions, the braking history, the number of traffic violations detected, etc.) and can also monitor vehicle maintenance data (e.g., how frequently the automobile has its oil changed, whether annual or bi-annual automobile maintenance is performed, etc.). Sensor devices 206a-206n can include any other type of device that monitors information about an individual's health, activities, home and/or home automation, and automobile in addition to those described above. In some embodiments, the processor 212 can receive data from such devices for processing by geographic region sensor data analysis engine 216 and sensor score calculation engine, and/or other components of the IOT-based score module 202.

In some embodiments, the IOT-based score module 202 can determine the geographic regions of each of the networked IOT sensor devices 206a-206n and their corresponding users whose data is being collected by the sensor devices 206a-206n. For example, the geographic region determination engine 214 can identify that a particular subset of sensor devices 206a-206n are located in a certain zipcode and/or geographic region and can accordingly associate metadata associated with the data collected from these devices to indicate the geographic region corresponding to the data collected by that subset of sensor devices. In some embodiments, the geographic region determination engine 214 can identify the location of each of the sensor devices and associate metadata with each device's collected data for further processing by the geographic region sensor data analysis engine 216. In some embodiments, the geographic region determination engine 214 can identify the geographic region and/or zipcode of a sensor device by querying the device to determine if it is aware of its own location. In some embodiments, the geographic region determination engine 214 can identify the geographic region and/or zipcode of a sensor device by processing through the data collected by the device to determine if there are any indications of location from the individual data points (e.g., location where the device was used to check in, landmarks that the user of a wearable device has passed by, social media check-ins comprising location information of the user using the sensor device, etc.).

In some embodiments, the IOT-based score module 202 can calculate an average score per type of sensor device and/or sensor data for each particular geographic region. For example, geographic region sensor data analysis engine 216 can determine what the median and/or average score is for each type of sensor data received from multiple different sensors of a given type with data on different individuals in a given geographic region. For example, once the IOT-based score module 202 receives data from a sensor device, the processor 212 can identify the type of data that is being collected and can associate a metadata identifier identifying the type of data (e.g., heart rate information, vehicle driving performance data, smart-home energy efficiency data, etc.) for that given collected sensor data. The geographic region sensor data analysis engine 216 can identify, from the metadata identifying the geographic location associated with the data by the geographic region determination engine 214, the geographic region corresponding to the particular sensor data and the type of sensor data from the metadata associated with the sensor. Once such sensor data is collected from sensor data measurements of multiple different individuals from the same geographic region, the geographic region sensor data analysis engine 216 can calculate an average and/or median score associated with each type of sensor data for each geographic region. Such a geographic region-based average and/or median score for each type of sensor measurement can be used to normalize a sensor device score for each particular individual to account for variations in particular scores across different geographic regions. Such a geographic normalization process can provide an improved and more accurate comparison of different individuals' sensor scores across different geographic regions. The geographic region sensor data analysis engine 216 can store the geographic scores for each sensor measurement for each given geographic region in the personal profile score database 207.

In some embodiments, the IOT-based score module 202 can assign a sensor score to a given individual based on the data collected from each monitored device sensor. For example, sensor score calculation engine 220 can calculate a score for each type of IOT score that is reported for each individual from each of the different sensor devices 206a-206n. For example, the sensor score calculation engine can process the received measurements from the sensor devices 202a-202n and can assign a sensor score for each type of sensor data corresponding to each of the sensor devices 202a-202n from which sensor data has been received. For example, upon receiving heart rate data for a given individual from a wearable heart rate sensor, the sensor score calculation engine 220 can assign a sensor score corresponding to the measured heart rate value. In some embodiments, the sensor score calculation engine 220 can be configured to convert the raw measurements received from the sensor devices 202a-202n based on preprogrammed instructions. For example, the sensor score calculation engine 220 can be configured to convert a heart rate of 100 beats/minute received from a sensor device 202a to a score of, for example, 168 by determining where in the range of heart rates the received heart rate falls and accordingly the sensor score calculation engine 220 can assign a score for that received heart rate measurement to a sensor score of 168 out of a maximum value of 200 for that individual. Such a sensor score per individual can be updated and/or averaged with multiple different measurements and/or data points received from the sensor device about that particular individual. The sensor score calculation engine 220 can be configured to identify which type of sensor data each sensor device 202a-202n corresponds to and, accordingly, sensor score calculation engine 220 can assign a score to a corresponding sensor data score upon processing the raw data measurements received from each sensor device. The sensor score calculation engine 220 can store the individual sensor scores assigned to the different individuals in the personal profile score database 207.

In some embodiments, the IOT-based score module 202 can assign weights to each different type of sensor data that is collected from sensor devices 202a-202n. For example, weightage engine 218 can assign a weight to each measured score from a particular device for a given individual. In some embodiments, such weights can be preset. In some other embodiments, the weightage engine 218 can automatically calculate the weight based on programmed rules. For example, the weightage engine 218 can be configured to automatically assign a total sum weight of a certain percent to a type of sensor (e.g., the sum of all automobile sensor data must equal a total weight of 0.3) and accordingly, once new automobile sensor data is received, the weighting of all other types of automobile data for that corresponding individual can be recalibrated such that the total sum weight of all automobile data equals a preset value. In some embodiments, the weightage engine 218 can assign a weight to each sensor value based on the amount of data available for each type of sensor. For example, sensors that produce a significantly higher quantity of data than other sensors and accordingly have significantly higher sensor scores (as a result of the vastly higher than average number of measurements received) can be assigned a lower weight. The weightage engine 218 can store the individual weights assigned to the different types of sensor measurements in the personal profile score database 207.

In some embodiments, the IOT-based score module 202 can calculate an adjusted personal profile score by weighting for each type of sensor score and can normalize each individual's sensor scores against the median and/or average scores for that corresponding type of sensor measurement in the local geographic region of the individual. For example, for each sensor score, score adjustment engine 222 can normalize the sensor score assigned to each individual against the average and/or median score corresponding to that sensor score and/or sensor type in the geographic region of the corresponding individual, as calculated by the geographic region sensor data analysis engine 216. By calibrating and/or normalizing each sensor score assigned to each individual against the corresponding average and/or median sensor score for that particular sensor measurement in a given geographic region, the score adjustment engine 222 can allow sensor scores across different regions to be compared on a standardized scale and avoid and/or filter out geographic biases affecting skews in particular types of sensor measurements for certain geographic regions. The score adjustment engine 222 can store the adjusted personal profile scores in the personal profile score database 207.

As embodied herein, the financial score module 204 can include a credit score determination engine 252 and an IOT-based financial score calculation engine 254. In some embodiments, the financial score module 204 can determine, for each individual for whom sensor measurements are received from sensor devices 202a-202n, whether that individual has a preexisting credit score (e.g., FICO score). For example, the credit score determination engine 252 can mine through and/or query a credit rating database 209 to determine if a given individual has a credit rating based on their financial history. As illustrated in FIG. 1, a credit rating database can include multiple credit ratings and/or credit scores 232a-232n of various different individuals based on their monitored financial histories. If the credit score determination engine 252 determines that a given individual does not have a preexisting credit score, the IOT-based financial score calculation engine 254 can assign the adjusted personal profile score for that individual calculated by the score adjustment engine 222 as the equivalent of a credit score to that individual's financial profile. However, if the credit score determination engine 252 determines that a given individual does have a preexisting credit score, the IOT-based financial score calculation engine 254 can supplement the credit score of the individual obtained from the credit rating database 209 with the adjusted personal profile score for that individual calculated by the score adjustment engine 222. For example, the IOT-based financial score calculation engine 254 can weight the credit score obtained from the credit rating database 209 and the adjusted personal profile score for that individual calculated by the score adjustment engine 222 to calculate a composite personal profile and assign the composite score to the individual's financial profile.

In some embodiments, once the personal profile score has been finalized for each individual, the personal profile score of different individuals can used to provide a measure of their creditworthiness. In some embodiments, the personal profile scores can be provided to financial institutions, credit bureaus, and any entity conducting background credit checks (e.g., home mortgages, car financing, loan refinancing, etc.) in addition to or in lieu of conventional credit scores of individuals to provide a more thorough, holistic and updated measure of the individuals' creditworthiness. In some embodiments, the IOT-based financial score calculation engine 254 can provide the personal profile score to other third party institutions in addition to creditors and/or lenders for applications in which these third party institutions require a quantifiable measure and/or metrics of the individuals' behaviors to determine how to more efficiently design their services for these individuals. For example, the IOT-based financial score calculation engine 254 can provide the generated personal profile scores to third party institutions such as insurance companies, retail banks, wealth management firms, credit and/or debit card companies, and several other institutions to provide metric(s) on the behavior, attentiveness, diligence, carefulness, creditworthiness, and/or other valuations of an individual's characteristics. Since the personal profile score can be constantly updated by IOT-based score module 202, the IOT-based financial score calculation engine 254 can provide real time measures of individuals' behaviors to help these institutions dynamically modify their services in real-time based on the IOT monitored data in real-time. For example, if an individual has been in an automobile collision due to his poor driving as reflected by IOT sensors within the individual's automobile or if the individual's home has been broken into because the individual forgot to lock the front back as indicated by a home security sensor, the IOT-based score module 202 can, in real-time, adjust the individual's personal profile score and a third party institution using that personal profile score of the individual can dynamically adjust the premiums being provided to that individual due to the decrease in their personal profile score. In some embodiments, the personal profile scores can be used for retail banking, card payment, insurance, wealth management, and savings purposes as a quantifiable measure of the user's monitored behaviors. For example, these institutions can use generated personal profile scores for individuals to determine whether to provide them with specific discounts, privileges, rewards, penalties, and/or to determine pricing based on the individuals' monitored behaviors as quantified by the personal profile scores.

In some embodiments, once the personal profile score has been finalized for each individual, the personal profile score of different individuals can used to provide a measure of the risk posed by individuals. For example, risk calculation module 208 can determine the amount of risk posed by an individual using at least in part the individual's personal profile score. As embodied herein, the risk calculation module 208 can include a processor 242, a risk assessment engine 244, and a risk-based premium update engine 246. In some embodiments, the risk calculation engine 208 can be used to calculate the amount of risk posed by the individual for purposes of insurance risk calculation. For example, the risk calculation module 208 can calculate the amount of risk an individual poses to his or her insurance policy (e.g., automobile insurance policy, home insurance policy, life insurance policy, etc.) based on their personal profile score. Under the direction of the processor 242, the risk assessment engine 244 can calculate a measure of insurance risk (e.g., automobile insurance risk, home insurance risk, life insurance risk, etc.) posed by the individual based on the personal profile score of the user and non-IOT based data obtained from other sources, resulting in an aggregate insurance risk score. For example, the risk assessment engine 244 can be configured to communicate with servers at an insurance company to retrieve data on the individual that the insurance company may possess (e.g., automobile driving and/or collision history, home break in and/or home damage history, medical history, etc.) and can calculate an aggregated insurance risk score based on this data retrieved from the insurance company and the personal profile score. In some embodiments, the IOT-based personal profile score can supplement other data points for quantifying the risk an individual poses from sources outside system 200 (e.g., insurance company servers, police records, medical records, DMV records, Kelly Blue Book reports, etc.). In some embodiments, the risk-based premium engine 246 can calculate an insurance premium to be charged to the individual by the insurance company based on the aggregate risk score generated by the risk assessment engine 244. For example, the risk-based premium engine 246 can determine, by comparing the aggregated risk score of the individual against predetermined aggregated risk score threshold values associated with different insurance premium costs, the corresponding insurance premium cost that an insurance company should charge the individual. In some embodiments, the risk-based premium engine 246 can determine actions that need to be taken based on the aggregate risk score generated by the risk assessment engine 244. For example, the risk-based premium engine 246 can send an alert to the individual (e.g., through a smartphone notification, email, automated phone call, etc.) that their monitored activities have raised their insurance premium to a specific amount and can offer tips on how to reduce their risk profile.

In some embodiments, the IOT-based score module 202 and risk calculation module 208 can be both a part of the same entity and can share computing resources. For example, the IOT-based score module 202 and risk calculation module 208 can share the same processor (i.e., processor 212 and processor 242 can be part of the same processor) and/or can share processing circuitry and/or processing software. In some other embodiments, the IOT-based score module 202 and risk calculation module 208 can be independent entities that do not share the same resources and can be located in different locations.

In some embodiments, the personal profile score can be periodically updated as additional measurement data is received from sensors 206a-206n. For example, the regional median and/or average scores for different types of sensors can change over time and can be updated as additional measurement data is received and sensor scores for each individual is updated. Accordingly, the adjusted personal profile score can also be updated over time as the sensor scores per individual for different types of sensors and the regional median and/or average scores is updated.

FIG. 2 is a diagram illustrating a representative method in which various components of the disclosed IOT-based score module can generate personal profile scores using a geo-location-based model of sensor data according to an illustrative embodiment of the disclosed subject matter.

According to the embodiment illustrated in FIG. 2, the geographic region data analysis engine 216 can obtain sensor measurements from sensor devices 206a-206n. As illustrated by the embodiment shown in FIG. 3, the sensor scores obtained from the sensor devices 206a-206n can be analyzed by the geographic region geographic region data analysis engine 216 to output a regional media sensor score per sensor type for each of the different types of sensor devices 206a-206n (i.e., regional media sensor score per sensor type 302a-302n). The geographic region data analysis engine 216 can determine, from the geographic region determination engine 214, a geographic region associated with each of the received sensor measurements from sensor devices 206a-206c. The geographic region data analysis engine 216 can calculate, for each of the plurality of different types of sensor measurements, an average of all received sensor measurements for a given type of sensor measurement that is associated with the geographic region. In some embodiments, the geographic region associated with each of the received sensor measurements can be determined by determining the geographic region at which a sensor producing the sensor measurements is located. In some embodiments, the geographic region associated with each of the received sensor measurements can be determined by determining the geographic region at which the individual corresponding to the received sensor measurements is located.

In some embodiments, weightage engine 218 can produce multiple different weights to assign to each type of sensor data obtained from sensors 206a-206n. For example, weightage engine 218 can calculate different weight values (i.e., Weight A per Sensor Type 304a-Weight N per Sensor Type 304n) for each of the different types of sensor measurements obtained from different sensor devices 206a-206n. In some embodiments, such weights can be preset. In some other embodiments, the weightage engine 218 can automatically calculate the weight based on programmed rules. In some embodiments, the weightage engine 218 can assign a weight to each sensor value based on the amount of data available for each type of sensor.

In some embodiments, sensor score calculation engine 220 can calculate different sensor scores for each individual. For example, based on the measurements and/or data received from each sensor device 206a-206n, the sensor score calculation engine 220 can produce a sensor score for each corresponding sensor device (i.e., Sensor A Score per Individual 306a-Sensor N Score per Individual 306n) for each individual for whom sensor data is provided from sensor devices 206a-206n. In some embodiments, the sensor score calculation engine 220 can determine the type of sensor measurement of each sensor measurement received from a sensor. In some embodiments, the sensor score calculation engine 220 can calculate an individual sensor score per individual based on one or more sensor measurements received from one or more of sensor devices 206a-206n corresponding to a particular type of sensor measurement. The individual sensor score can be calculated by comparing the one or more sensor measurements against a range of expected values for the determined type of sensor measurement.

In some embodiments, the score adjustment engine 222 can calculate the adjusted individual score 308 based on the regional median and/or average scores, the sensor scores per individual, and the weights per sensor types. For example, the score adjustment engine 222 can receive, as inputs, the regional media scores per sensor type 302a-302n, the sensor scores per individual 306a-306n, and the weights per sensor types 304a-304n. Based on this input information, the score adjustment engine 222 can determine the adjusted personal profile score 308. In some embodiments, the score adjustment engine 222 can calculate the adjusted personal profile score using the following equations (1) and (2):

$$\begin{matrix}Adjusted Sensor Score Per Type of Sensor Measurement = \frac{\begin{matrix}Sensor Score per Individual \times \\ Weight per Sensor Type\end{matrix}}{\begin{matrix}Regional Median or Average Sensor \\ Score Per Sensor Type\end{matrix}} & ( 1 ) \\ Adjusted personal profile score = {\sum }_{a}^{n} Adjusted Sensor Score Per Type of Sensor Measurement & ( 2 )\end{matrix}$$

FIG. 3 is a diagram illustrating a representative database 400 generated by the disclosed IOT-based score module to generate personal profile scores using a geo-location-based model of sensor data according to an illustrative embodiment of the disclosed subject matter. In some embodiments, database 400 can correspond to personal profile score database 207 of FIG. 1.

In the embodiment illustrated in FIG. 3, database 400 can include various different individual sensor scores for several different users (i.e., Persons A and B) as shown in columns 450 and 450 for person A and person B, respectively. For example, the sensor score calculation engine 220 can assign each of these individual sensor scores (e.g., target heart rates, car mileage efficiency, car braking history, home application usage during peak times, etc.) based on the measurement data received from sensor devices 206a-206n for each individual. By collecting such data from IOT devices associated with multiple individuals in several different geographic regions, the geographic region sensor data analysis engine 216 can calculate regional median and/or average sensor scores for each individual type of sensor measurement for each geographic region (i.e., NYC—Midtown, Williamsburg, Hoboken) as shown in columns 410, 420, and 430. The weightage engine 218 can store the weight associated with each type of sensor measurement in column 440. By applying equation (1) described above, the score adjustment engine 222 can calculate the adjusted sensor score for each type of sensor measurement (i.e., modified score) for each individual as shown in columns 460 and 480 for person A and person B, respectively. By summing up the adjusted sensor scores for each type of sensor measurement for each individual, the score adjustment engine 222 for each individual according to equation (2) (i.e., net scores 490 and 492 for person A and person B, respectively).

FIG. 4 is a flow chart illustrating a representative method 500, for generating personal profile scores using a geo-location based model of sensor data. The exemplary system 200 of FIG. 1, method 300 of FIG. 2, and database of FIG. 3, for purpose of illustration and not limitation, are discussed with reference to the exemplary method 500 of FIG. 4.

As embodied herein, at 502, the processor can receive measurement data from sensors. For example, processor 212 of IOT-based score module 202 can receive sensor measurements from sensor devices 206a-206n reflecting IOT sensor measurements for different individuals. Such measurement data can be analyzed by the IOT-based score module 202 to generate a personal profile score reflecting a measure of creditworthiness of each of the different individuals based on their monitored IOT sensor data.

At 504, the processor can identify the geographic location of each sensor and/or the individual associated with each sensor. For example, the geographic region determination engine 514 can determine the geographic region at which a sensor producing the sensor measurements is located. Additionally or alternatively, the geographic region determination engine 514 can determine the geographic region at which the individual corresponding to the received sensor measurements is located.

At 506, the processor can calculate sensor scores for each individual based on the received measurement data. For example, based on the measurements and/or data received from each sensor device 206a-206n, the sensor score calculation engine 220 can produce a sensor score for each corresponding sensor device (i.e., Sensor A Score per Individual 306a-Sensor N Score per Individual 306n) for each individual for whom sensor data is provided from sensor devices 206a-206n. The individual sensor score can be calculated by comparing the one or more sensor measurements against a range of expected values for the determined type of sensor measurement.

At 508, the processor can calculate regional median scores for each geographic region based on the received measurement data. For example, the geographic region data analysis engine 216 can calculate, for each of the plurality of different types of sensor measurements, an average of all received sensor measurements for a given type of sensor measurement that is associated with the geographic region.

At 510, the processor can calculate weights for each type of received sensor measurement. In some embodiments, such weights can be preset. In some other embodiments, the weightage engine 218 can automatically calculate the weight based on programmed rules. In some embodiments, the weightage engine 218 can assign a weight to each sensor value based on the amount of data available for each type of sensor.

At 512, the processor can calculate the adjusted personal profile score for each individual based on weights, individual sensor scores, and regional median sensor scores. For example, the score adjustment engine 222 can receive, as inputs, the regional media scores per sensor type 302a-302n, the sensor scores per individual 306a-306n, and the weights per sensor types 304a-304n. Based on this input information, the score adjustment engine 222 can determine the adjusted personal profile score 308. In some embodiments, the score adjustment engine 222 can calculate the adjusted personal profile score using the following equations (1) and (2) described above.

At 514, the processor can determine whether an individual has a preexisting credit score and/or data regarding the insurance risk that individual poses to insurance companies. For example, the credit score determination engine 252 can mine through and/or query a credit rating database 209 to determine if a given individual has a credit rating based on their financial history. The risk assessment engine 244 can be configured to communicate with servers at an insurance company to retrieve data on the individual that the insurance company may possess (e.g., automobile driving and/or collision history, home break in and/or home damage history, medical history, etc.).

At 516, in response to determining that the individual does have a preexisting credit score, the processor can calculate a composite personal profile score using the adjusted personal profile score and the preexisting credit score. For example, if the credit score determination engine 252 determines that a given individual does have a preexisting credit score, the IOT-based financial score calculation engine 254 can supplement the credit score of the individual obtained from the credit rating database 209 with the adjusted personal profile score for that individual calculated by the score adjustment engine 222. For example, the IOT-based financial score calculation engine 254 can weight the credit score obtained from the credit rating database 209 and the adjusted personal profile score for that individual calculated by the score adjustment engine 222 to calculate a composite personal profile and assign the composite score to the individual's financial profile.

At 517, in response to determining that the individual does have preexisting insurance risk data, the processor can calculate an aggregated insurance risk score using the adjusted personal profile score and the preexisting insurance risk data. For example, if the risk assessment engine 244 determines that a given individual does have preexisting insurance risk data, the risk assessment engine 244 can calculate an aggregated insurance risk score based on this data retrieved from the insurance company and the personal profile score. In some embodiments, the risk assessment engine 244 can supplement the IOT-based personal profile score with other data points for quantifying the risk an individual poses from sources outside system 200 (e.g., insurance company servers, police records, medical records, DMV records, Kelly Blue Book reports, etc.). In some embodiments, the risk-based premium engine 246 can calculate an insurance premium to be charged to the individual by the insurance company based on the aggregate risk score generated by the risk assessment engine 244.

At 518, in response to determining that the individual does not have a preexisting credit score and/or does not have preexisting insurance risk data, the processor can assign the adjusted personal profile score to the financial and/or insurance profile of the individual in lieu of a preexisting credit score and/or preexisting insurance risk data. For example, if the credit score determination engine 252 determines that a given individual does not have a preexisting credit score, the IOT-based financial score calculation engine 254 can assign the adjusted personal profile score for that individual calculated by the score adjustment engine 222 as the equivalent of a credit score to that individual's financial profile and provide that score to third parties requesting a creditworthiness score for an individual. For example, if the risk calculation module 208 determines upon querying the insurance company's servers that a given individual does not have any associated preexisting insurance risk data in their insurance risk profile, the risk calculation module 208 can assign the adjusted personal profile score for that individual calculated by the score adjustment engine 222 as the equivalent of an insurance risk metric to that individual's insurance profile and provide that score to insurance companies and/or third parties requesting an insurance risk score for an individual.

FIG. 5 is a block diagram illustrating further details of a representative computer system according to an illustrative embodiment of the disclosed subject matter.

The systems and techniques discussed herein can be implemented in a computer system. As an example and not by limitation, as shown in FIG. 5, the computer system having architecture 600 can provide functionality as a result of processor(s) 601 executing software embodied in one or more tangible, non-transitory computer-readable media, such as memory 603. The software implementing various embodiments of the present disclosure can be stored in memory 603 and executed by processor(s) 601. A computer-readable medium can include one or more memory devices, according to particular needs. Memory 603 can read the software from one or more other computer-readable media, such as mass storage device(s) 635 or from one or more other sources via communication interface 620. The software can cause processor(s) 601 to execute particular processes or particular parts of particular processes described herein, including defining data structures stored in memory 603 and modifying such data structures according to the processes defined by the software. An exemplary input device 633 can be, for example, a keyboard, a pointing device (e.g., a mouse), a touchscreen display, a microphone and voice control interface, a pressure sensor or the like to capture user input coupled to the input interface 623 to provide data and/or user input to the processor 601. An exemplary output device 634 can be, for example, a display (e.g., a monitor) or speakers or a haptic device coupled to the output interface 624 to allow the processor 601 to present a user interface, visual content, and/or audio content. Additionally or alternatively, the computer system 600 can provide an indication to the user by sending text or graphical data to a display 632 coupled to a video interface 622. Furthermore, any of the above components can provide data to or receive data from the processor 601 via a computer network 630 coupled the communication interface 620 of the computer system 600. In addition or as an alternative, the computer system can provide functionality as a result of logic hardwired or otherwise embodied in a circuit, which can operate in place of or together with software to execute particular processes or particular parts of particular processes described herein. Reference to software or executable instructions can encompass logic, and vice versa, where appropriate. Reference to a computer-readable media can encompass a circuit (such as an integrated circuit (IC)) storing software or executable instructions for execution, a circuit embodying logic for execution, or both, where appropriate. The present disclosure encompasses any suitable combination of hardware and software.

In some embodiments, processor 601 includes hardware for executing instructions, such as those making up a computer program. As an example and not by way of limitation, to execute instructions, processor 601 can retrieve (or fetch) the instructions from an internal register, an internal cache 602, memory 603, or storage 608; decode and execute them; and then write one or more results to an internal register, an internal cache 602, memory 603, or storage 608. In particular embodiments, processor 601 can include one or more internal caches 602 for data, instructions, or addresses. This disclosure contemplates processor 601 including any suitable number of any suitable internal caches, where appropriate. As an example and not by way of limitation, processor 601 can include one or more instruction caches 602, one or more data caches 602, and one or more translation lookaside buffers (TLBs). Instructions in the instruction caches 602 can be copies of instructions in memory 603 or storage 608, and the instruction caches 602 can speed up retrieval of those instructions by processor 601. Data in the data caches 602 can be copies of data in memory 603 or storage 608 for instructions executing at processor 601 to operate on; the results of previous instructions executed at processor 601 for access by subsequent instructions executing at processor 601 or for writing to memory 603 or storage 608; or other suitable data. The data caches 602 can speed up read or write operations by processor 601. The TLBs can speed up virtual-address translation for processor 601. In some embodiments, processor 601 can include one or more internal registers for data, instructions, or addresses. This disclosure contemplates processor 601 including any suitable number of any suitable internal registers, where appropriate. Where appropriate, processor 601 can include one or more arithmetic logic units (ALUs); be a multi-core processor; or include one or more processors 601. Although this disclosure describes and illustrates a particular processor, this disclosure contemplates any suitable processor.

In some embodiments, memory 603 includes main memory for storing instructions for processor 601 to execute or data for processor 601 to operate on. As an example and not by way of limitation, computer system 600 can load instructions from storage 608 or another source (such as, for example, another computer system 600) to memory 603. Processor 601 can then load the instructions from memory 603 to an internal register or internal cache 602. To execute the instructions, processor 601 can retrieve the instructions from the internal register or internal cache 602 and decode them. During or after execution of the instructions, processor 601 can write one or more results (which can be intermediate or final results) to the internal register or internal cache 602. Processor 601 can then write one or more of those results to memory 603. In some embodiments, processor 601 executes only instructions in one or more internal registers or internal caches 602 or in memory 603 (as opposed to storage 608 or elsewhere) and operates only on data in one or more internal registers or internal caches or in memory 603 (as opposed to storage 608 or elsewhere). One or more memory buses (which can each include an address bus and a data bus) can couple processor 601 to memory 603. Bus 640 can include one or more memory buses, as described below. In particular embodiments, one or more memory management units (MMUs) reside between processor 601 and memory 603 and facilitate accesses to memory 603 requested by processor 601. In some embodiments, memory 603 includes random access memory (RAM). This RAM can be volatile memory, where appropriate. Where appropriate, this RAM can be dynamic RAM (DRAM) or static RAM (SRAM).

Moreover, where appropriate, this RAM can be single-ported or multi-ported RAM. This disclosure contemplates any suitable RAM. Memory 603 can include one or more memories 604, where appropriate. Although this disclosure describes and illustrates particular memory, this disclosure contemplates any suitable memory.

In some embodiments, storage 608 includes mass storage for data or instructions. As an example and not by way of limitation, storage 608 can include a hard disk drive (HDD), a floppy disk drive, flash memory, an optical disc, a magneto-optical disc, magnetic tape, or a Universal Serial Bus (USB) drive or a combination of two or more of these. Storage 608 can include removable or non-removable (or fixed) media, where appropriate. Storage 608 can be internal or external to computer system 600, where appropriate. In some embodiments, storage 608 is non-volatile, solid-state memory. In some embodiments, storage 608 includes read-only memory (ROM). Where appropriate, this ROM can be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 608 taking any suitable physical form. Storage 608 can include one or more storage control units facilitating communication between processor 601 and storage 608, where appropriate. Where appropriate, storage 608 can include one or more storages 608. Although this disclosure describes and illustrates particular storage, this disclosure contemplates any suitable storage.

In some embodiments, input interface 623 and output interface 624 can include hardware, software, or both, providing one or more interfaces for communication between computer system 600 and one or more input device(s) 633 and/or output device(s) 634. Computer system 600 can include one or more of these input device(s) 633 and/or output device(s) 634, where appropriate. One or more of these input device(s) 633 and/or output device(s) 634 can enable communication between a person and computer system 600. As an example and not by way of limitation, an input device 633 and/or output device 634 can include a keyboard, keypad, microphone, monitor, mouse, printer, scanner, speaker, still camera, stylus, tablet, touch screen, trackball, video camera, another suitable input device 633 and/or output device 634 or a combination of two or more of these. An input device 633 and/or output device 634 can include one or more sensors. This disclosure contemplates any suitable input device(s) 633 and/or output device(s) 634 and any suitable input interface 623 and output interface 624 for them. Where appropriate, input interface 623 and output interface 624 can include one or more device or software drivers enabling processor 601 to drive one or more of these input device(s) 633 and/or output device(s) 634. Input interface 623 and output interface 624 can include one or more input interfaces 623 or output interfaces 624, where appropriate. Although this disclosure describes and illustrates a particular input interface 623 and output interface 624, this disclosure contemplates any suitable input interface 623 and output interface 624.

As embodied herein, communication interface 620 can include hardware, software, or both providing one or more interfaces for communication (such as, for example, packet-based communication) between computer system 600 and one or more other computer systems 600 or one or more networks. As an example and not by way of limitation, communication interface 620 can include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 620 for it. As an example and not by way of limitation, computer system 600 can communicate with an ad hoc network, a personal area network (PAN), a local area network (LAN), a wide area network (WAN), a metropolitan area network (MAN), or one or more portions of the Internet or a combination of two or more of these. One or more portions of one or more of these networks can be wired or wireless. As an example, computer system 600 can communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 can include any suitable communication interface 620 for any of these networks, where appropriate. Communication interface 620 can include one or more communication interfaces 620, where appropriate. Although this disclosure describes and illustrates a particular communication interface, this disclosure contemplates any suitable communication interface.

In some embodiments, bus 640 includes hardware, software, or both coupling components of computer system 600 to each other. As an example and not by way of limitation, bus 640 can include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 640 can include one or more buses 604, where appropriate. Although this disclosure describes and illustrates a particular bus, this disclosure contemplates any suitable bus or interconnect.

Herein, a computer-readable non-transitory storage medium or media can include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium can be volatile, non-volatile, or a combination of volatile and non-volatile, where appropriate.

The foregoing merely illustrates the principles of the disclosed subject matter. Various modifications and alterations to the described embodiments will be apparent to those skilled in the art in view of the teachings herein. It will thus be appreciated that those skilled in the art will be able to devise numerous techniques which, although not explicitly described herein, embody the principles of the disclosed subject matter and are thus within its spirit and scope.

1. A computer-implemented method for generating personal profile scores, comprising:
receiving, at a processor and from a plurality of sensors, a plurality of different types of sensor measurements for each of a plurality of individuals;
calculating, by the processor and for each of the plurality of individuals, individual sensor scores corresponding to each of the plurality of different types of sensor measurements;
calculating, by the processor, a regional average score for each of the plurality of different types of sensor measurements based on the sensor measurements from a subset of the plurality of sensors associated with individuals located in a particular geographic region;
determining, by the processor and for each of the plurality of individuals, an adjusted sensor score for each of the plurality of different types of sensor measurements, wherein the adjusted sensor score for each type of sensor measurement comprises an individual sensor score normalized by a corresponding regional average score for that corresponding type of sensor measurement; and
determining, by the processor and for each of the plurality of individuals, an adjusted personal profile score by compositing the adjusted sensor scores for each of the plurality of different types of sensor measurements.

2. The computer-implemented method of claim 1, further comprising:
determining, by the processor and for each of the plurality of different types of sensor measurements, a weighting value corresponding to that type of sensor measurement.

3. The computer-implemented method of claim 2, wherein the adjusted profile score is calculated by compositing weighted adjusted sensor scores for each of the plurality of different types of sensor measurements, and wherein a weighted adjusted score comprises an adjusted score for a particular type of sensor measurement weighted by the weighting value corresponding to that type of sensor measurement.

4. The computer-implemented method of claim 1, wherein each of the plurality of sensors is a networked device that communicates, to the processor, a particular type of sensor measurement comprising measurement data collected for an individual.

5. The computer-implemented method of claim 1, wherein calculating the individual sensor scores further comprises:
determining, by the processor, the type of sensor measurement of each sensor measurement received from a sensor;
calculating, by the processor, an individual sensor score based on one or more sensor measurements received from one or more of the plurality of sensors corresponding to a particular type of sensor measurement, wherein the individual sensor score is calculated by comparing the one or more sensor measurements against a range of expected values for the determined type of sensor measurement.

6. The computer-implemented method of claim 1, wherein calculating a regional average score further comprises:
determining, by the processor, a geographic region associated with each of the received sensor measurements;
calculating, by the processor and for each of the plurality of different types of sensor measurements, an average of all received sensor measurements for a given type of sensor measurement that is associated with the geographic region.

7. The computer-implemented method of claim 6, wherein the geographic region associated with each of the received sensor measurements can be determined by performing at least one of:
determining, by the processor, the geographic region at which a sensor producing the received sensor measurements is located; and
determining, by the processor, the geographic region at which the individual corresponding to the received sensor measurements is located.

8. The computer-implemented method of claim 1, further comprising determining, by the processor, whether an individual has a preexisting credit score based on a financial history of the individual.

9. The computer-implemented method of claim 8, further comprising:
upon determining that individual has a preexisting credit score, generating, by the processor, a composite personal profile score based on the preexisting credit score and the adjusted personal profile score.

10. The computer-implemented method of claim 8, further comprising:
upon determining that individual does not have a preexisting credit score, providing, by the processor, the adjusted personal profile score as a measure of creditworthiness of the individual in lieu of a credit score to entities that require a credit score.

11. An apparatus for generating personal profile scores, comprising:
a processor configured to communicate with a plurality of sensors, the processor configured to:
receive, from the plurality of sensors, a plurality of different types of sensor measurements for each of a plurality of individuals;
calculate, for each of the plurality of individuals, individual sensor scores corresponding to each of the plurality of different types of sensor measurements;
calculate a regional average score for each of the plurality of different types of sensor measurements based on the sensor measurements from a subset of the plurality of sensors associated with individuals located in a particular geographic region;
determine, for each of the plurality of individuals, an adjusted sensor score for each of the plurality of different types of sensor measurements, wherein the adjusted sensor score for each type of sensor measurement comprises an individual sensor score normalized by a corresponding regional average score for that corresponding type of sensor measurement; and
determine, for each of the plurality of individuals, an adjusted personal profile score by compositing the adjusted sensor scores for each of the plurality of different types of sensor measurements.

12. The apparatus of claim 11, wherein the processor is further configured to:
determine, for each of the plurality of different types of sensor measurements, a weighting value corresponding to that type of sensor measurement.

13. The apparatus of claim 12, wherein the processor is configured to determine the adjusted profile score by compositing weighted adjusted sensor scores for each of the plurality of different types of sensor measurements, and wherein a weighted adjusted score comprises an adjusted score for a particular type of sensor measurement weighted by the weighting value corresponding to that type of sensor measurement.

14. The apparatus of claim 11, wherein each of the plurality of sensors is a networked device that communicates, to the processor, a particular type of sensor measurement comprising measurement data collected for an individual.

15. The apparatus of claim 11, wherein the processor is configured to calculate the individual sensor scores by being further configured to:
determine the type of sensor measurement of each sensor measurement received from a sensor;
calculate an individual sensor score based on one or more sensor measurements received from one or more of the plurality of sensors corresponding to a particular type of sensor measurement, wherein the individual sensor score is calculated by comparing the one or more sensor measurements against a range of expected values for the determined type of sensor measurement.

16. The apparatus of claim 11, wherein the processor is configured to determine a regional average score by being further configured to:
determine a geographic region associated with each of the received sensor measurements;
calculate, for each of the plurality of different types of sensor measurements, an average of all received sensor measurements for a given type of sensor measurement that is associated with the geographic region.

17. The apparatus of claim 16, wherein the processor is configured to determine the geographic region associated with each of the received sensor measurements by being further being configured to perform at least one of:
determining the geographic region at which a sensor producing the received sensor measurements is located; and
determining the geographic region at which the individual corresponding to the received sensor measurements is located.

18. The apparatus of claim 11, wherein the processor is configured to determine whether an individual has a preexisting credit score based on a financial history of the individual.

19. The apparatus of claim 18, wherein upon determining that individual has a preexisting credit score, the processor is configured to generate a composite personal profile score based on the preexisting credit score and the adjusted personal profile score.

20. The apparatus of claim 18, wherein upon determining that individual does not have a preexisting credit score, the processor is configured to provide the adjusted personal profile score as a measure of creditworthiness of the individual in lieu of a credit score to entities that require a credit score.
